(19) United States
(12) Patent Application Publication
(10) Pub. No.: US 2006/0168289 A1
(43) Pub. Date: Jul. 27, 2006

(54) System and method for signaling clients for multimedia streaming

(75) Inventors: Ru-Shang Wang, Coppell, TX (US); Keith Miller, Plano, TX (US)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 11/026,946

(22) Filed: Dec. 30, 2004

(51) Int. Cl. G06F 15/16

(52) U.S. Cl. 709/231

(57) ABSTRACT

Methods, devices, systems, program products and computer-implemented methods for communication of non-interleaved and interleaved packets of streamed data are disclosed. A method of streaming multimedia includes transmitting a signal from a client device to a multimedia server. The signal is indicative of desired settings for the client device to receive packets of streamed data. The desired settings include at least one of an amount of a total buffer memory allocated to buffering of interleaved packets and an indication of acceptability of all packetization types available to the server.

### FIELD OF THE INVENTION

The present invention relates to multimedia streaming. In particular, the invention provides systems and methods for signaling clients of broadcast or multicast multimedia streaming services.

### BACKGROUND OF THE INVENTION

In a multimedia streaming system, a server computer transmits a stream of data to one or more client devices as a multicast or a broadcast. Each of the client devices may be provided with a different connection condition and different capability. These variations can lead to numerous issues related to the playback of the data at the client devices. For example, the client device may suffer through interruptions during the playback, requiring rebuffering of the data. Also, playbacks at various client devices may differ, causing playback to occur at different times at each device. Thus, for example, one client device may playback the final score of a sporting event before other client devices.

### SUMMARY OF THE INVENTION

The present invention is directed to methods, devices, systems, program products, and computer-implemented methods adapted for multicasting or broadcasting of streamed data.

In one embodiment, a method of streaming multimedia includes streaming data from a streaming server to one or more receiving devices, the data including a series of packets to be decoded by the receiving devices; and providing each device with timing information, next-packet and last-sent packet information, the timing information being indicative of a desired playback schedule.

In another embodiment, a method for multimedia streaming includes receiving streamed data from a streaming server by a receiving device, the data including a series of packets to be decoded; and receiving timing information, next-packet and last-sent packet information from the streaming server, the timing information being indicative of a desired playback schedule.

In another embodiment, a client device adapted to receive streamed data includes a communication module adapted to receive streamed data from a streaming server, the data including a series of packets to be decoded. The communication module is further adapted to receive timing information, next-packet and last-sent packet information from then streaming server, the timing information being indicative of a desired playback schedule. The client device also includes a decoder adapted to determine a desired buffering based on the timing information and next-packet information.

In another embodiment, a system for multimedia streaming includes a server computer and one or more client devices. The server computer is adapted to transmit streamed data, the data including a series of packets to be decoded. The server computer is further adapted to transmit timing information, next-packet and last-sent packet information from the streaming server, the timing information being indicative of a desired playback schedule. Each client device is adapted to receive said streamed data, timing information and next-packet information.

Another embodiment of the invention includes a program product having machine readable program code for causing a machine to perform the following: streaming data from a streaming server to one or more receiving devices, the data including a series of packets to be decoded by the receiving devices; and providing each device with timing information and next-packet information, the timing information being indicative of a desired playback schedule.

In another embodiment, a computer-implemented method includes streaming data from a streaming server to one or more receiving devices, the data including a series of packets to be decoded by the receiving devices; and providing each device with timing information, next-packet and last-sent packet information, the timing information being indicative of a desired playback schedule.

In another embodiment, the invention includes a program product having machine readable program code for causing a machine to perform the following: receiving streamed data from a streaming server by a receiving device, the data including a series of packets to be decoded; and receiving timing information, next-packet and last-sent packet information from the streaming server, the timing information being indicative of a desired playback schedule.

In another embodiment, a computer-implemented method includes receiving streamed data from a streaming server by a receiving device, the data including a series of packets to be decoded; and receiving timing information, next-packet and last-sent packet information from the streaming server, the timing information being indicative of a desired playback schedule.

Other principle features and advantages of the invention will become apparent to those skilled in the art upon review of the following drawings, the detailed description, and the appended claims.

### BRIEF DESCRIPTION OF THE DRAWINGS

Exemplary embodiments will hereafter be described with reference to the accompanying drawings, in which:

FIG. 1 is a diagrammatic representation of a system for multimedia streaming in accordance with an exemplary embodiment;

FIG. 2 is an exemplary RTCP SR packet;

FIG. 3 is an RTCP APP packet in accordance with an exemplary embodiment; and

FIG. 4 is a timeline associated with an exemplary RTCP APP packet.

### DETAILED DESCRIPTION OF EXEMPLARY EMBODIMENTS

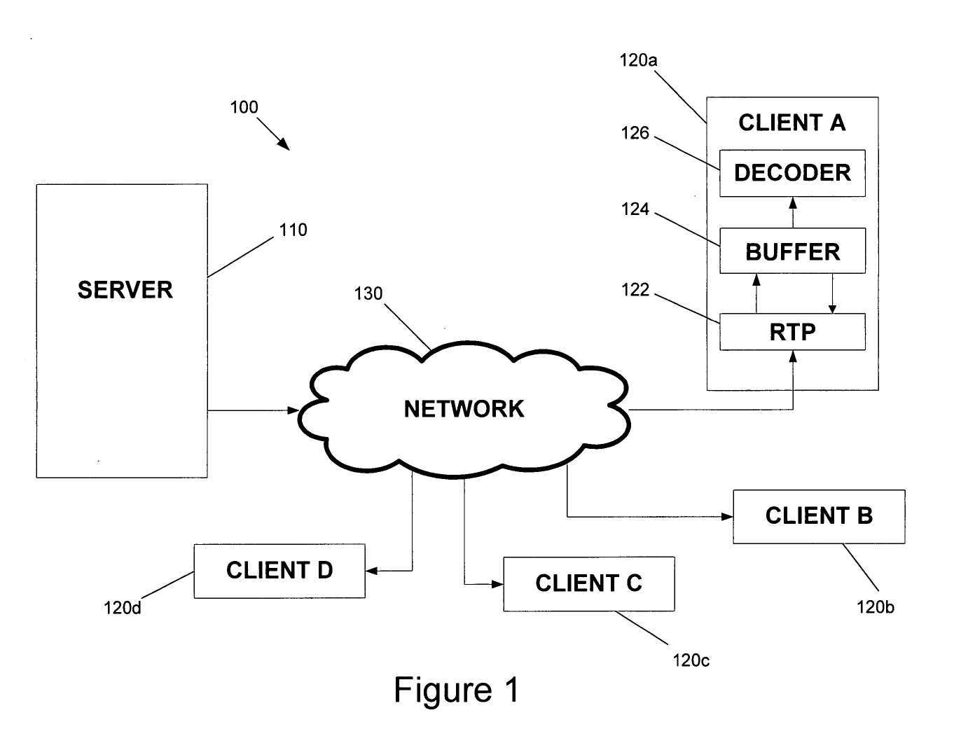

FIG. 1 is a diagrammatic representation of a system for multimedia streaming in accordance with an exemplary embodiment. The system 100 includes a server computer 110 adapted to transmit streamed data to one or more client devices, such as client devices 120a-d. The client devices may be any of a variety of wireless devices, such as handheld phones, for example. The data may be transmitted through any number of communication systems, including networks, such as a communication network 130. The communication network 130 may be a public communication network, such as the Internet, or a wireless communication network, such as a cellular telephone network.

Such streamed data is typically transmitted by the server computer as packets of data using the Realtime Transport Protocol (RTP) and Realtime Transport Control Protocol (RTCP) in accordance with the 3^{rd} Generation Partnership Project (3GPP) Packet Switched Streaming Service (PSS) requirements.

The server 110 may be adapted to provide any type of streamed data, including audio, video or a combination thereof. The server 110 may be adapted to send RTP packets. In this regard, the server 110 may include one or more components (not shown) to encode data for streaming. In this regard, the server 110 is adapted to encode the data in interleaved or non-interleaved packets for streaming.

The packets of data are transmitted to the client devices 120a-d, where they are initially received by a communication module, such as communication module 122 of client device 120a, adapted to receive RTP packets. The communication module 122 may be adapted to store the data in a buffer memory 124. A decoder 126 can decode the data for playback to the user.

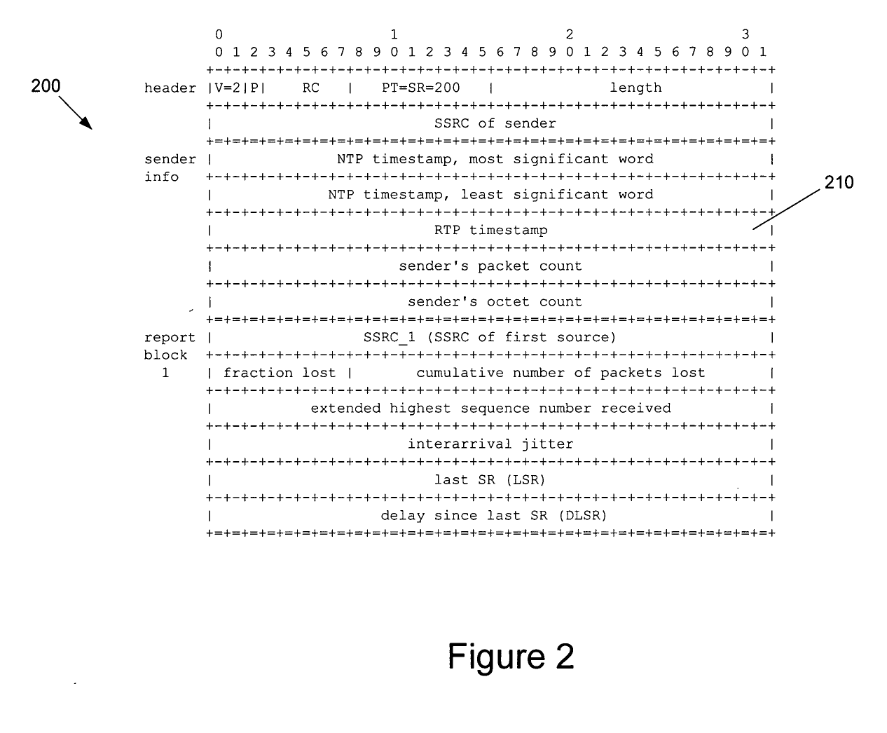

FIG. 2 illustrates an exemplary RTCP sender report (SR) packet. The RTCP SR packet 200 is a typical RTCP SR packet which includes an RTP timestamp 210 indicative of a clock setting corresponding to the data packet.

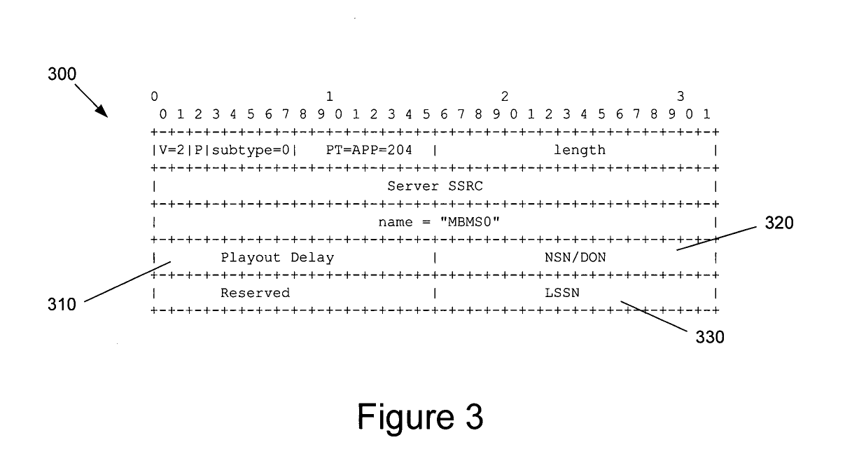

In addition to the information contained in the RTCP SR packet 200, in embodiments of the present invention, information relating to next packet to be decoded and the timing information, such as playout delay of the current packet, may be included. In one embodiment, as data packets are streamed to the client devices, such information may be transmitted in RTCP application specific (APP) packets, an example of which is illustrated in FIG. 3. The RTCP APP packet 300 and the RTCP SR packet 200 may be transmitted as a compound packet.

The RTCP APP packet 300 illustrated in FIG. 3 includes fields corresponding to standard type 204 packets, as defined in RFC 1889. The standard type 204 packet includes application-dependent data following the name field. In the illustrated embodiment, the application-dependent data includes a playout delay 310, a next-to-be-decoded sequence number (NSN) 320 and a last-sent packet sequence number (LSSN) 330.

The playout delay 310 is used to indicate when the streaming server assumes that each client device should start to decode the packet indicated by the NSN 320. The LSSN 330 allows each client to determine the designed buffer level of the streamed data.

The combination of the information in the RTCP SR packet 200 and the RTCP APP packet 300 allows each client device to determine when to start playback. Further, the information allows each client to calculate how to adaptively schedule the playback speed to accommodate for any channel variation. This provides an improved continuous playback.

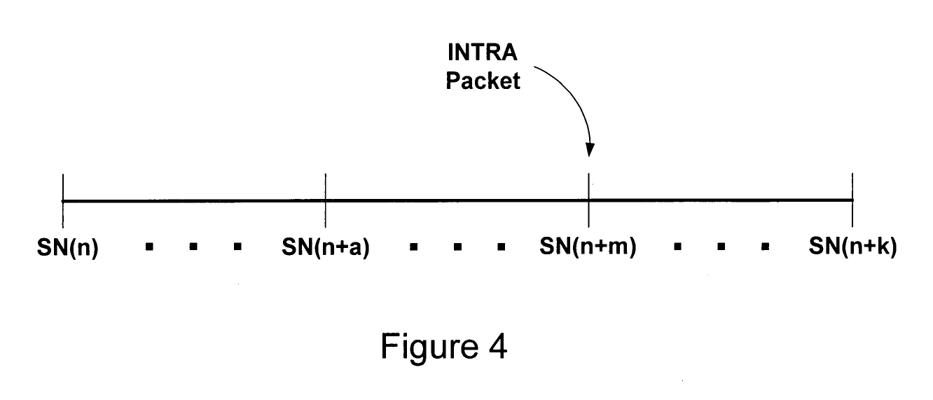

Specifically, the information in the RTCP SR packets and the RTCP APP packets allows the client device to determine the designed buffer level at a certain time. An example of this is illustrated below with reference to FIG. 4.

FIG. 4 illustrates a timeline of packets to be decoded. Assuming that a particular client device connects to the streaming server and first receives the packet SN(n). When the client device receives an RTCP APP packet, the client device can determine that the latest packet received by the client device is SN(n+k). The NSN associated with the RTCP APP packet may indicate an earlier packet, SN(n+a). The client device may note a timestamp associated with the NSN packet, SN(n+a).

For RTP/RTCP streamed data, playback begins with the reception of an Intra, or IDR, packet, which contains information required for decoding of the stream. In the example illustrated in FIG. 4, the Intra packet, SN(n+m), is between the NSN packet associated with the RTCP APP packet, SN(n+a), and the latest packet to be received, SN(n+k). The client device can then determine the timestamp associated with the Intra packet, SN(n+m), and determine the required buffer time as the difference between the timestamps of the Intra packet, SN(n+m), and the NSN packet associated with the RTCP APP packet, SN(n+a).

During playback, the continuity of the playback may be maintained by using the playout delay 310 indicated in the RTCP APP packet (FIG. 3). In this regard, upon reception of each RTCP APP packet, the decoding and playout of the NSN packet 320 can be appropriately scheduled by the client device.

Although the above exemplary embodiment illustrates the use of an RTCP APP packet to provide each client device with certain information, in other embodiments, the information may be provided through, for example, session description protocol (SDP) or real-time streaming protocol (RTSP) signaling.

Certain client devices may be equipped with a Global Positioning System (GPS) capability. Such a capability may provide the client device with an accurate clock. In such devices, the client device may utilize the NTP timestamp (FIG. 2) to schedule the decoding and playback of the NSN packet.

Thus, in addition to the streamed data, each client device is provided with timing information and the next packet identification to allow the client device to determine an appropriate buffering requirement and to schedule the decoding for an accurate and continuous playback.

In the foregoing description, for purposes of explanation, numerous specific details are set forth in order to provide a thorough understanding of the present invention. It is evident, however, to one skilled in the art that the exemplary embodiments may be practiced without these specific details. In other instances, structures and devices are shown in block diagram form in order to facilitate description of the exemplary embodiments.

While the exemplary embodiments illustrated in the Figures and described above are presently preferred, it should be understood that these embodiments are offered by way of example only. Other embodiments may include, for example, different techniques for performing the same operations. The invention is not limited to a particular embodiment, but extends to various modifications, combinations, and permutations that nevertheless fall within the scope and spirit of the appended claims.

What is claimed is:

1. A method for multimedia streaming, comprising:
streaming data from a streaming server to one or more receiving devices, the data including a series of packets to be decoded by the receiving devices; and
providing each device with timing information, next-packet information and last-sent packet information, the timing information being indicative of a desired playback schedule.

2. The method of claim 1, wherein the step of providing includes transmitting an application-specific (RTCP APP) packet.

3. The method of claim 2, wherein the RTCP APP packet includes application-dependent information, the application-dependent information including a next-to-be-decoded packet sequence number.

4. The method of claim 3, wherein the application-dependent information further includes a last-sent packet sequence number.

5. The method of claim 4, wherein the application-dependent information further includes a playout delay indicative of a desired playback schedule.

6. A method for multimedia streaming, comprising:
a) receiving streamed data from a streaming server by a receiving device, the data including a series of packets to be decoded; and
b) receiving timing information, next-packet information and last-sent packet information from the streaming server, the timing information being indicative of a desired playback schedule.

7. The method of claim 6, wherein step b) includes receiving an application-specific (RTCP APP) packet.

8. The method of claim 7, wherein the RTCP APP packet includes application-dependent information, the application-dependent information including a next-to-be-decoded packet sequence number.

9. The method of claim 8, wherein the application-dependent information further includes a last-sent packet sequence number.

10. The method of claim 9, wherein the application-dependent information further includes a playout delay indicative of a desired playback schedule.

11. The method of claim 6, further comprising:
c) determining a desired buffering based on the timing information, next-packet information and last-sent packet information.

12. A client device adapted to receive streamed data, the device comprising:
a communication module adapted to receive streamed data from a streaming server, the data including a series of packets to be decoded, the communication module being further adapted to receive timing information, next-packet information and last-sent packet information from the streaming server, the timing information being indicative of a desired playback schedule; and
a decoder adapted to determine a desired buffering based on the timing information, next-packet information and last-sent packet information.

13. The client device of claim 12, wherein the communication module is adapted to receive at least a part of the timing information and the next-packet information in an application-specific (RTCP APP) packet.

14. The client device of claim 13, wherein the RTCP APP packet includes application-dependent information, the application-dependent information including a next-to-be-decoded packet sequence number.

15. The client device of claim 14, wherein the application-dependent information further includes a last-sent packet sequence number.

16. The client device of claim 15, wherein the application-dependent information further includes a playout delay indicative of a desired playback schedule.

17. A system for multimedia streaming, comprising:
a server computer adapted to transmit streamed data, the data including a series of packets to be decoded, the server computer being further adapted to transmit timing information, next-packet information and last-sent packet information from the streaming server, the timing information being indicative of a desired playback schedule; and
one or more client devices, each client device being adapted to receive said streamed data, timing information, next-packet information and last-sent packet information.

18. The system of claim 17, wherein each client device includes a decoder adapted to determine a desired buffering based on the timing information, next-packet information and last-sent packet information.

19. The system of claim 17, wherein the server computer is adapted to transmit at least a part of the timing information and the next-packet information in an application-specific (RTCP APP) packet.

20. The system of claim 19, wherein the RTCP APP packet includes application-dependent information, the application-dependent information including a next-to-be-decoded packet sequence number.

21. The system of claim 20, wherein the application-dependent information further includes a last-sent packet sequence number.

22. The system of claim 21, wherein the application-dependent information further includes a playout delay indicative of a desired playback schedule.

23. The system of claim 17, wherein at least one client device is a mobile device.

24. The system of claim 17, wherein the streamed data is transmitted by the server to at least one client device through a communication network.

25. The system of claim 24, wherein the communication network is a wireless network.

26. A program product, comprising machine readable program code for causing a machine to perform the following:
streaming data from a streaming server to one or more receiving devices, the data including a series of packets to be decoded by the receiving devices; and
providing each device with timing information, next-packet information and last-sent packet information, the timing information being indicative of a desired playback schedule.

27. A computer-implemented method, comprising:
streaming data from a streaming server to one or more receiving devices, the data including a series of packets to be decoded by the receiving devices; and
providing each device with timing information, next-packet information and last-sent packet information, the timing information being indicative of a desired playback schedule.

28. A program product, comprising machine readable program code for causing a machine to perform the following:
a) receiving streamed data from a streaming server by a receiving device, the data including a series of packets to be decoded; and
b) receiving timing information, next-packet information and last-sent packet information from the streaming server, the timing information being indicative of a desired playback schedule

29. A computer-implemented method, comprising:
a) receiving streamed data from a streaming server by a receiving device, the data including a series of packets to be decoded; and
b) receiving timing information, next-packet information and last-sent packet information from the streaming server, the timing information being indicative of a desired playback schedule.
